(19) United States
(12) Patent Application Publication
(10) Pub. No.: US 2008/0005560 A1
(43) Pub. Date: Jan. 3, 2008

(54) Independent Computation Environment and Provisioning of Computing Device Functionality

(75) Inventors: James Duffus, Seattle, WA (US); Thomas G. Phillips, Bellevue, WA (US); Alexander Frank, Bellevue, WA (US); William J. Westerinen, Issaquah, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/427,666

(22) Filed: Jun. 29, 2006

(51) Int. Cl. H04L 9/00; G06F 1/00

(52) U.S. Cl. 713/164; 713/300

(57) ABSTRACT

Techniques are described which provide an independent computation environment. The independent computation environment is contained at least in part in a set of one or more hardware components and configured to host a provisioning module that is executable to provision functionality of the computing device according to a wide variety of factors. In an implementation, when the provisioning module determines that particular functionality is referenced in an inclusion list, the computing device is permitted to access the particular functionality. When the provisioning module determines that the particular functionality is referenced in an exclusion list, the computing device is prevented from accessing the particular functionality.

### BACKGROUND

In traditional business models, consumers purchased both computing devices and software for execution on the computing devices. Therefore, traditional computing devices were typically configured for “open” and “general purpose” execution of software and access to services desired by the user and not limited, by itself, to execution of particular software and/or access to particular services.

Under these traditional business models, for instance, the consumer may purchase a desktop personal computer (PC) having an operating system that permits execution of a wide range of applications, such as games, word processors, spreadsheets, and so on that may be obtained from a wide range of venders. Additionally, one or more of these applications (e.g., a browser) may permit access to a wide variety of services, such as web pages and so on. Therefore, a provider (e.g., manufacturer) of the desktop PC typically used a configuration that enabled the PC to execute as many of these different applications as possible, which may provide access to as many services as possible. In this way, the functionality available to the consumer and consequently the desirability of the PC to the consumer was increased.

Configuration as a “general purpose” computing device, however, typically limited the computing device to these traditional business models and thus limited sellers of the computing device from availing themselves of other business models. For example, a seller may wish to use a business model in which consumers “pay-as-they-go”. Therefore, in this example, a seller of the computing device may subsidize the initial purchase price of the computing device in order to collect revenue from the user at a later time, such as in the sale of services and/or software to the consumer over a network. However, if the computing device is configured for general purpose execution of software, the consumer may choose to forgo use of the seller's services and/or software, thereby removing the incentive for the seller to subsidize the cost of the computing device.

### SUMMARY

Techniques are described which provide an independent computation environment, which may be used to control functionality in an “open” and “general purpose” computing device. The independent computation environment is contained at least in part in a set of one or more hardware components. The independent computation environment is configured to host a provisioning module that is executable to provision functionality of the computing device according to a wide variety of factors.

In an implementation, the provisioning module is executed in the independent computation environment. When the provisioning module determines that particular functionality is referenced in an inclusion list, the computing device is permitted to access the particular functionality. When the provisioning module determines that the particular functionality is referenced in an exlusion list, the computing device is prevented from accessing the particular functionality.

In another implementation, a computing device is provided which is bound to access one or more web services of a service provider through use of a provisioning module. The provisioning module is executable in an independent computation environment contained at least in part in one or more hardware components of the computing device. At least a portion of a purchase price of the computing device is subsidized.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an exemplary implementation that is operable to employ techniques to provide an independent computation environment.

FIG. 2 is an illustration of a system in an exemplary implementation showing a service provider and a computing device of FIG. 1 in greater detail.

FIG. 3 is an illustration of an architecture including an independent computation environment that measures the health of one or more sets of subject code running in memory.

FIG. 4 is an illustration of an architecture including an independent computation environment incorporated in a processor that measures the health of one or more sets of subject code running in memory.

FIG. 5 is an illustration showing an exemplary timing diagram representing various time windows that may exist with respect to measuring the health of subject code.

FIG. 6 is a flow diagram depicting a procedure in an exemplary implementation in which a subsidized computing device is provided that is bound to one or more web services.

FIG. 7 is a flow diagram depicting a procedure in an exemplary implementation in which a module is executed on a computing device which is bound to interaction with a particular web service.

FIG. 8 is a flow diagram depicting a procedure in an exemplary implementation in which a balance is used to manage functionality of a computing device through execution of a provisioning module in an independent computation environment.

FIG. 9 is a flow diagram depicting a procedure in an exemplary implementation in which inclusion and exclusion lists are used to manage functionality of a computing device.

FIG. 10 is a flow diagram depicting a procedure in an exemplary implementation in which different identification techniques are used in conjunction with respective inclusion/exclusion lists to manage execution of a module.

### DETAILED DESCRIPTION

Overview

Traditional business models enabled a consumer to purchase a computing device (e.g., a desktop personal computer) that was configured to execute software that was also purchased by the consumer. Therefore, this traditional business model provided two streams of revenue, one to the manufacturer and seller of the computing device and another to a developer and seller of the software. Additionally, a third stream of revenue may be obtained by a seller of web services that may be consumed via the computing device, such as prepaid access to particular web sites. Thus, traditional computing devices were configured for “open” and “general purpose” usage such that the consumer was not limited by the computing device to execution of particular software nor access to particular web services. By configuring a computing device for general purpose usage, however, the computing device may not be suitable for use in other business models, such as in models that subsidize all or a portion of a purchase price of the computing device in order to collect revenue later from use of the device.

Techniques are described, in which, an independent computation environment is created, which may be used to ensure execution of particular software. This particular software, for instance, may be configured to provision functionality of the computing device according to policies that specify desired operation of the computing device. A seller, for instance, may use a “pay-per-use” model in which the seller gains revenue through the sale of prepaid cards that enable use of the computing devices for a limited amount of time, for a predetermined number of times, to perform a predetermined number of functions, and so on. In another instance, a software provider provides subscription-based use of software. In a further instance, a service provider provides access to web services for a fee. In these instances, the policies may specify how functionality of the computing device is to be managed to ensure that the computing device is used in a manner to support this model. For example, the user may be limited to use of the computing device in conjunction with particular web services, access to which is gained by paying a fee. Therefore, the service provider may subsidize the cost of the computing device in order to obtain revenue from the user when accessing the services. A variety of other examples are also contemplated.

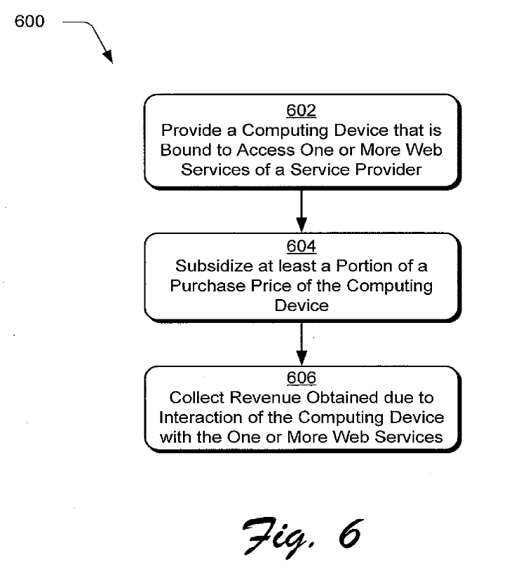

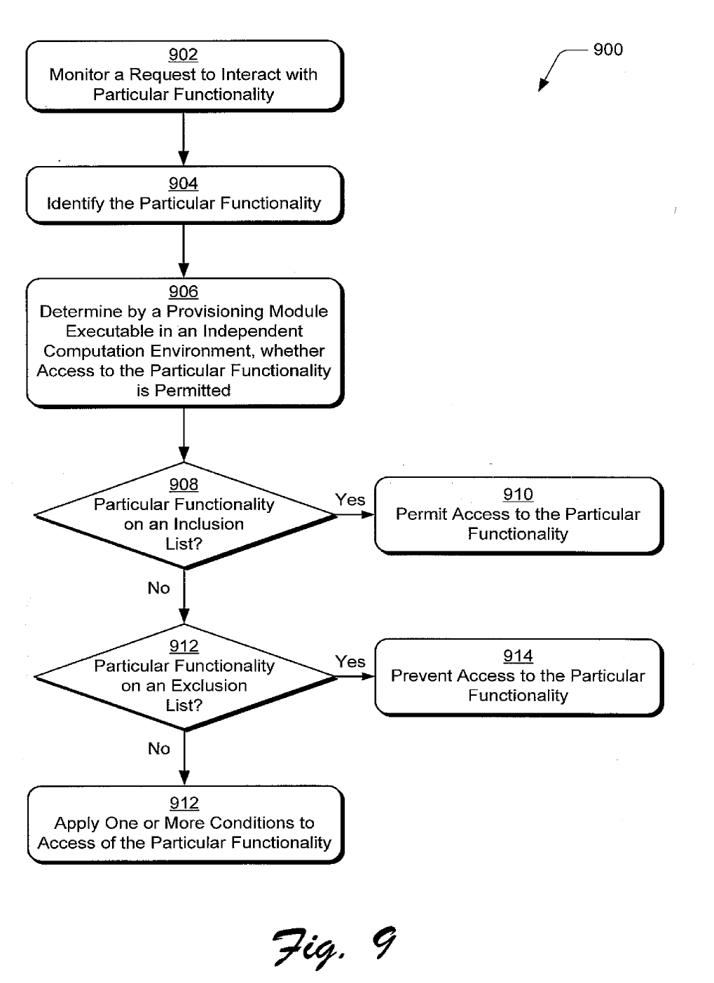

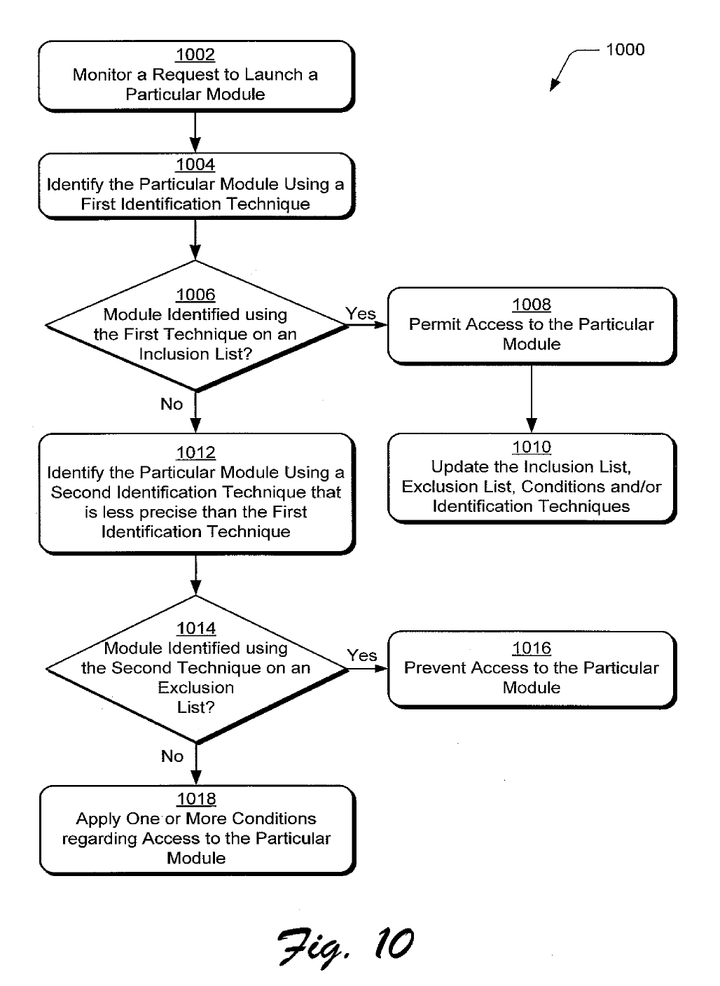

A variety of techniques may be used by the independent computation environment to manage functionality of the computing device. For example, the provisioning module, when executed, may manage which applications and/or web services are permitted to interact with the computing device through inclusion and exclusion lists. Inclusion lists may specify which functionality (e.g., applications, web services, and so on) are permitted to be used by the computing device. Exclusion lists, on the other hand, may specify which functionality is not permitted, such as by specifying pirated applications, untrusted web sites, and so on. Therefore, after identifying the web service or application which is to be used in conjunction with the computing device, the provisioning module may determine whether to permit the action. Further, the provisioning module may also employ policies for applications and/or web services that address instances in which the functionality is not referenced in the inclusion or exclusion lists. Further discussion of managing use of the computing device with particular web services may be found in relation to FIGS. 6-8. Further discussion of the use of exclusion and exclusion lists may be found in relation to FIGS. 9-10.

In the following discussion, an exemplary environment and devices are first described that are operable to perform techniques to provide an independent execution environment. Exemplary procedures are then described that may be employed in the exemplary environment and/or implemented by the exemplary devices, as well as in other environments and/or devices.

Exemplary Environment

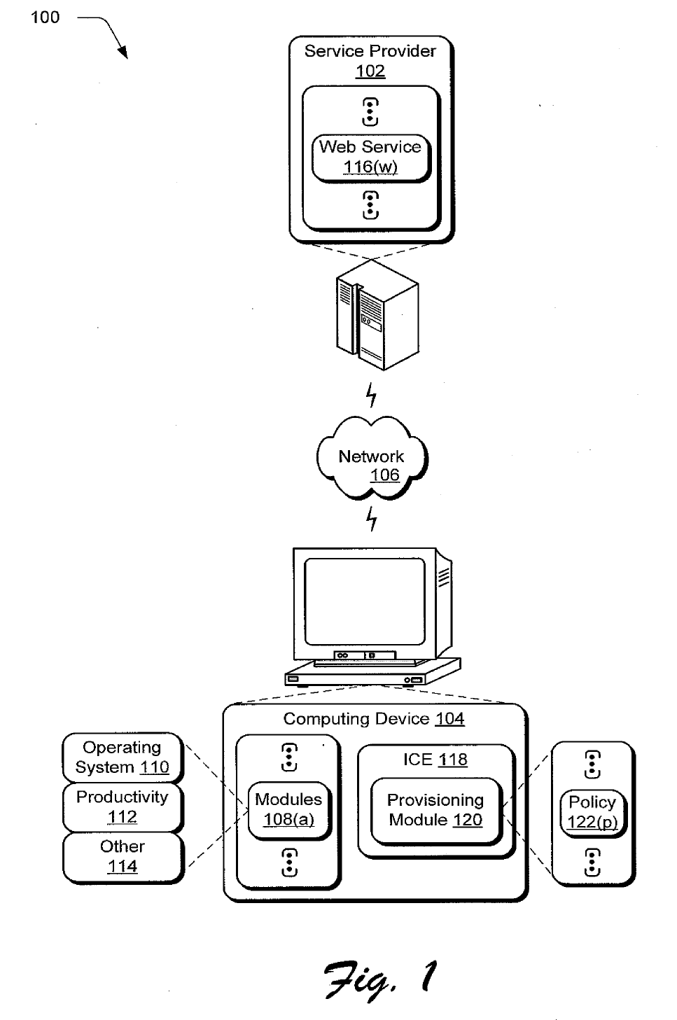

FIG. 1 is an illustration of an environment 100 in an exemplary implementation that is operable to employ techniques that provide an independent computation environment. The illustrated environment 100 includes a service provider 102 and a computing device 104 that are communicatively coupled, one to another, via a network 106. In the following discussion, the service provider 102 may be representative of one or more entities, and therefore reference may be made to a single entity (e.g., the service provider 102) or multiple entities (e.g., the service providers 102, the plurality of service providers 102, and so on).

The computing device 104 may be configured in a variety of ways. For example, the computing devices 104 may be configured as a desktop computer, a mobile station, an entertainment appliance, a set-top box communicatively coupled to a display device, a wireless phone, a game console, and so forth. Thus, the computing device 104 may range from full resource device with substantial memory and processor resources (e.g., personal computers, game consoles) to low-resource device with limited memory and/or processing resources (e.g., traditional set-top box, hand-held game console).

Although the network 106 is illustrated as the Internet, the network may assume a wide variety of configurations. For example, the network 106 may include a wide area network (WAN), a local area network (LAN), a wireless network, a public telephone network, an intranet, and so on. Further, although a single network 106 is shown, the network 106 may be configured to include multiple networks.

The computing device 104 is illustrated as having one or more modules 108(a) (where “a” can be any integer from one to “A”, which is also referred to in instances in the following discussion as “code” and “sets of code”). The modules 108(a) may be configured in a variety of ways to provide a variety of functionality. For example, one of the modules 108(a) may be configured as an operating system 110 that provides a basis for execution of other modules 108(a). The other modules 108(a), for instance, may be configured as productivity applications 112, such as word processors, spreadsheets, slideshow presentation applications, graphical design applications, and note-taking applications. The modules 108(a) may also be configured in a variety of other 114 ways, such as a game, configured for network access (e.g., a browser), and so on. For instance, the module 108(a), when executed, may interact with one or more web services 116(w) over the network 106. Further, the modules 108(a) may be configured to add functionality to other modules, such as through configuration as a “plug in” module.

As previously described, under traditional business models, computing devices were typically configured for “general purpose” and “open” use to enable a user to access a wide range of modules and/or web services as desired. However, such “general purpose” and “open” configuration limited the computing device from taking advantage of other business models, in which, cost of the computing device was subsidized by another entity, such as a software provider, network access provider, web service provider, and so on. For instance, these other entities may collect revenue from use of web services and therefore subsidize the cost of the computing device to encourage users to use the web services. In another example, a “pay-per-use” model may be used, in which, the initial cost of the computing device is subsidized and the user pays for use of the computing device in a variety of ways, such as a subscription fee, a fee paid for a set amount of time, a fee paid for use of a set amount of resources, and so on.

Therefore, the computing device 104 of FIG. 1 is configured to provide an environment, in which, execution of particular software may be secured to enforce use of the computing device 104 in a manner desired by a manufacturer/seller of the computing device 104. Various aspects of the technology described herein, for instance, are directed towards a technology by which any given piece of software code may be measured for verification (e.g., of its integrity and authenticity) in a regular, ongoing manner that effectively takes place in real-time. As used herein, the term “measure” and its variants (e.g., “measured,” “measuring,” “measurement” and so forth) with respect to software code generally refers to any abstraction for integrity and/or authentication checks, in which there are several ways to validate integrity and/or authentication processes. Some example ways to measure are described below, however this measurement abstraction is not limited to those examples, and includes future techniques and/or mechanisms for evaluating software code and/or its execution.

The modules 108(a) may be measured, for instance, and some penalty applied in the event that the modules 108(a) are not verified as “healthy”, e.g., functions as intended by a seller of the computing device. For example, as a penalty, the computing device 104 may be shut down when executing an “unhealthy” module, may reduce its performance in some way (at least in part) that makes normal usage impractical, may force an administrator to contact a software vendor or manufacturer for a fix/permission, the unhealthy module may be stalled, (e.g., by trapping) and so forth. Similar techniques may also be applied in relation to access to web services 116(w).

In general and as described above, replaceable or modifiable software, as is the situation with an open operating system, is generally not an acceptable mechanism for measuring the health of other software code. Instead, techniques are described, in which, a hardware-aided mechanism/solution (e.g., processor based) provides for an external root of trust that is independent of the operating system 110. As also described below, to measure the integrity of sets of code such as binary modules, the hardware mechanism may take actions to compensate for the lack of a real-time method, and also may provide data about the execution of each subject binary module to help reach a conclusion about its health.

In one example implementation, the hardware mechanism comprises an independent (sometimes alternatively referred to as isolated) computation environment (or ICE) 118, comprising any code, microcode, logic, device, part of another device, a virtual device, an ICE modeled as a device, integrated circuitry, hybrid of circuitry and software, a smartcard, any combination of the above, any means (independent of structure) that performs the functionality of an ICE described herein, and so forth, that is protected (e.g., in hardware) from tampering by other parties, including tampering via the operating system 110, bus masters, and so on.

The ICE 118 enables independent computation environment-hosted logic (e.g., hardwired logic, flashed code, hosted program code, microcode and/or essentially any computer-readable instructions) to interact with the operating system 110, e.g., to have the operating system suggest where the subject modules supposedly reside. Multiple independent computation environments are feasible. For instance, an independent computation environment that monitors multiple different network addresses, multiple memory regions, different characteristics of the multiple memory regions, and so on may suffice.

The ICE 118, for instance, is illustrated as including a provisioning module 120 which is representative of logic that applies one or more policies 122(p) (where “p” can be any integer from one to “P”) which describe how functionality of the computing device 104 is to be managed. By verifying the provisioning module 120 for execution on the computing device 104, for instance, the computing device 104 may be prevented from being “hacked” and used for other purposes that lie outside of the contemplated business model. Further, the provisioning module 120, when executed within the ICE 118, may measure the “health” of the other modules 108(a) to ensure that these modules 108(a) function as described by the policy 122(p).

The provisioning module 120, for instance, may enforce a policy to control which web services 116(w) are accessible by the computing device 104. For example, the provisioning module 120 may monitor execution of the modules 108(a) to ensure that network addresses employed by the modules 108(a) to access web services 116(w) are permitted. Additionally, the service provider 102 that provides the web services 116(w) may collect a fee from a user of the computing device 104 for accessing the web services 116(w). These fees may be used to support a “subsidy” business model, in which, the service provider 102 may then offset part of the initial purchase cost of the computing device 104 in order to collect these fees at a later time, further discussion of which may be found in relation to FIG. 6.

In another example, the provisioning module 120 is executable to enforce a policy 122(p) that permits access to modules 108(a) and/or web services 116(w) based on inclusion and exclusion lists. The provisioning module 120, for instance, may use precise identification techniques (e.g., cryptographic hashing) to determine whether a module 108(a) is included in a list of “permissible” functionality that may be employed by the computing device 104. The provisioning module 120 may also use identification techniques (which may be less precise than those used for the inclusion list, such as signature measures) to determine whether the module 108(a) and/or web service 116(w) is on a list of functionality that is excluded from use on the computing device 104. Further, the policy 122(p) employed by the provisioning module 120 may also specify a wide variety of actions to take when functionality (e.g., the modules 108(a) and/or the web services 116(w)) are not included in either of the lists, further discussion of which may be found in relation to the following figure.

Generally, any of the functions described herein can be implemented using software, firmware, hardware (e.g., fixed logic circuitry), manual processing, or a combination of these implementations. The terms “module,” “functionality,” and “logic” as used herein generally represent software, firmware, hardware or a combination thereof. In the case of a software implementation, the module, functionality, or logic represents program code that performs specified tasks when executed on a processor (e.g., CPU or CPUs). The program code can be stored in one or more computer readable memory devices, e.g., memory. The features of the techniques described below are platform-independent, meaning that the techniques may be implemented on a variety of commercial computing platforms having a variety of processors.

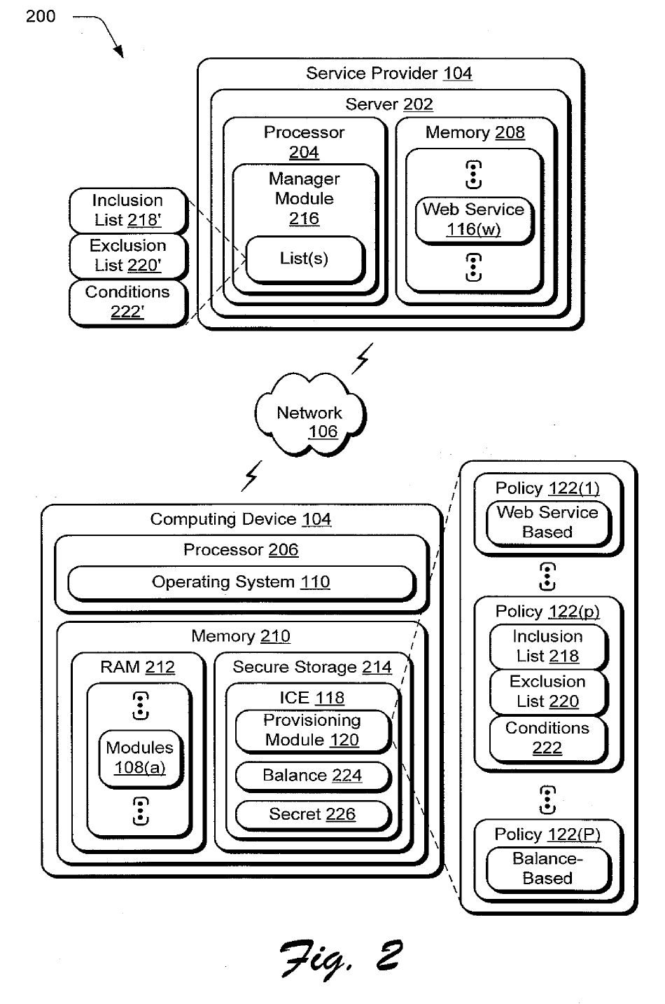

FIG. 2 illustrates a system 200 in an exemplary implementation showing the service provider 102 and the computing device 104 of FIG. 1 in greater detail. The service provider 102 is illustrated as being implemented by a server 202, which may be representative of one or more servers, e.g., a server farm. The server 202 and the computing device 104 are each illustrated as having respective processors 204, 206 and respective memory 208, 210.

Processors are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions. Alternatively, the mechanisms of or for processors, and thus of or for a computing device, may include, but are not limited to, quantum computing, optical computing, mechanical computing (e.g., using nanotechnology), and so forth.

Additionally, although a single memory 208, 210 is shown, respectively, for the service provider 102 and the computing device 104, a wide variety of types and combinations of memory may be employed, such as random access memory (RAM), hard disk memory, removable medium memory, and other types of computer-readable media. For example, the memory 210 of the computing device 104 is illustrated as including volatile memory configured as Random Access Memory (RAM) 212 and also includes secure storage 214 which is illustrated as separate from the RAM 212.

The secure storage 214 may be configured in a variety of ways, such as through System Management Random Access Memory (SMRAM), a part of memory 210 used to contain a Basic Input/Output System (BIOS), as a “smart chip” that employs encryption which may be independently validated using a hash or equivalent, and so on. In an implementation, the secure storage 214 is not accessible (read or write access) to the operating system 110 nor to the other modules 108(a) which “exist outside” of the ICE 118. In another implementation, however, all or a part of the secure storage 214 is available for read access, but not write access to the “outside” modules 108(a).

As previously described, the provisioning module 120 is representative of functionality to enforce policies 122(1)-122(P) related to the functionality of the computing device 104, which may be configured in a variety of ways. Policy 122(1), for instance, is illustrated as being “web service based” such that this policy may be used by the provisioning module 120 to determine which web services 116(w) are permitted to be accessed using the computing device 104. The provisioning module 120, for instance, may use a root of trust in modified hardware of the ICE 118 to validate at boot time that certain software components and user interface elements are present, executing and pointing to permitted network addresses (e.g., Uniform Resource Locators (URLs), Internet Protocol (IP) addresses, and so on).

These software components, in turn, may perform mutual authentication with the web services 116(w) of the service provider 102 through interaction with a manager module 216, which is illustrated as being executed on the processor 204 and is storable in memory 208. In another instance, authentication of the software components with the manager module 216 of the service provider 104 is performed via the provisioning module 120. The service provider 104, through execution of the manager module 216, may also receive verification (which may be signed) that the web services 116(w) were consumed by the computing device 104. Thus, the policy 122(1) in this instance may provide for monetization of the web services 116(w) and leverage this monetization toward subsidizing an initial purchase price of the computing device 104 by a consumer. Further discussion of provisioning based on web services may be found in relation to FIGS. 6-8.

In another instance, policy 122(p) is illustrated as being configured to control functionality of the computing device 104 through use of an inclusion list 218, an exclusion list 220 and conditions 222. For example, the provisioning module 120 may be executable to identify modules 108(a) and/or web services 116(w), such as through cryptographic hashing, use of digital signature techniques, and so on. The provisioning module 120 may then compare this identification with the inclusion list 218 to determine whether access to this functionality is expressly permitted, and if so, permit access. For example, the inclusion list 218 may include a list of network addresses and cryptographic hashes of permitted functionality, such as modules 108(a) from an entity that subsidized the initial purchase price of the computing device 104.

The provisioning module 120 may also compare this identification with the exclusion list 220 to determine whether access to this functionality is expressly restricted. For example, the exclusion list 220 may include cryptographic hashes of pirated forms of the applications and therefore the provisioning module 120, when executed, may exclude those modules from being executed on the computing device 104. Further, the policy 122(p) may specify conditions 222 for actions to be taken when a module and/or web service is not in either list, such as to permit execution for a limited amount of time until an update of the inclusion of exclusion lists (illustrated as lists including updated versions of the inclusion list 218′, exclusion list 220′ and conditions 222′) may be obtained from the service provider 104. Further discussion of provisioning based on inclusion and exclusion lists may be found in relation to FIGS. 9-10.

In yet another instance, policy 122(P) is illustrated as being based on a balance 224 maintained by the computing device 104. In the illustrated implementation, the provisioning module 120 is executed to enforce a policy 122(P) that specifies a plurality of functional modes for the computing device 104, the enforcement of which is based on a balance 224 maintained locally on the computing device 104. For example, the plurality of functional modes may include a full function mode, in which, the computing device 104 is permitted to execute the modules 108(a) using the full resources (e.g., processor 206, memory 210, network and software) of the computing device 104.

A reduced function mode may also be provided, in which, the functionality of the computing device 104 is limited, such as by permitting limited execution of the application modules 108(a). For example, the reduced function mode may prevent execution of the application modules 108(a) past a certain amount of time, thereby enabling a user to save and transfer data, but does not permit extended interaction with the application modules 108(a).

Further, a hardware lock mode may also be specified, in which, execution of software other than the provisioning module 120 is prevented. For example, the hardware lock mode may prevent execution of the operating system 110 on the processor 206 altogether, and consequently the execution of the modules 108(a) that depend on the operating system 110 to use resources of the computing device 104.

Each of these different operational modes may be entered depending on the balance 224. Therefore, adjustment of the balance 224 may cause entry into the different modes and therefore be used to control the functionality of the computing device. The balance 224, for instance, may support a “pay-per-use” business model, in which, the balance 224 is decremented at periodic intervals. For instance, the provisioning module 120 may be executed at periodic intervals due to periodic output of a hardware interrupt (e.g., by an embedded controller) of the computing device 104 that helps for form the ICE 118. Therefore, the provisioning module 120 may also decrement the balance 224 when executed during these periodic intervals and thus “lower” the balance as the computing device 104 is being used.

To “raise” the balance, the computing device 104 may be associated with a particular account maintained by the manager module 216 of the service provider 102. For example, the manager module 216 may cause a provisioning packet to be communicated over the network 106 to the computing device 104, such as in response to an input received from a human operator of the service provider 102 (e.g., customer support personnel), automatically and with user intervention through interaction with the provisioning module 120 (e.g., communication of an identifier which is used to retrieve billing information from the consumer's account, and so on. The provisioning packet, when received by the provisioning module 120, may be used to “raise” the balance 224 and therefore regain/maintain access to the functionality of the computing device 104. A variety of other instances are also contemplated, in which, policies are used to provisioning functionality of the computing device 104.

The computing device 104 is further illustrated as maintaining a secret 226 within secure storage 214, which may be utilized in a variety of ways. For example, the secret 226 may be configured as a root of trust that is used to verify modules 108(a) and web service 116(w) interaction. The secret 226, for instance, may be configured as a private key of a public/private key pair that is used by the provisioning module 120 to verify whether access to the modules 108(a) on the computing device 104 should be permitted. A variety of other examples are also contemplated, further discussion of which may be found in relation to the exemplary procedures.

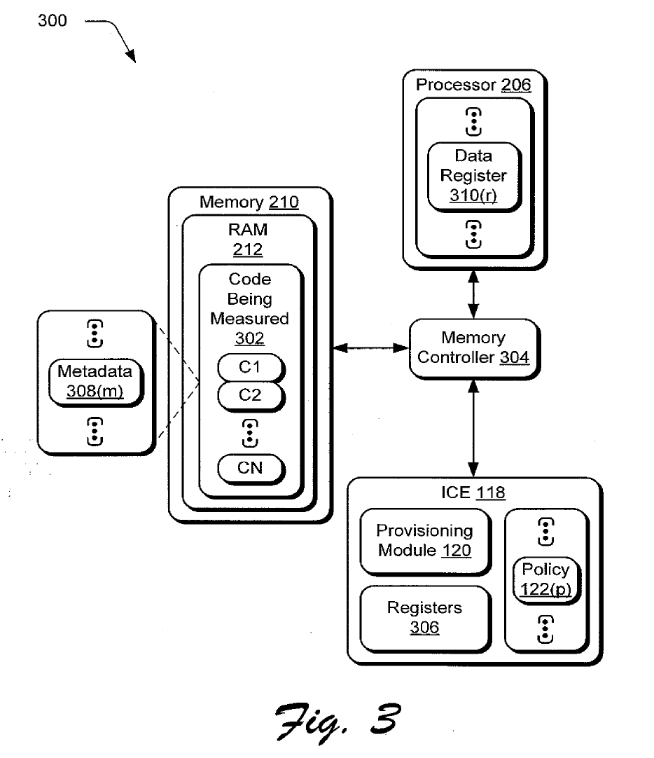

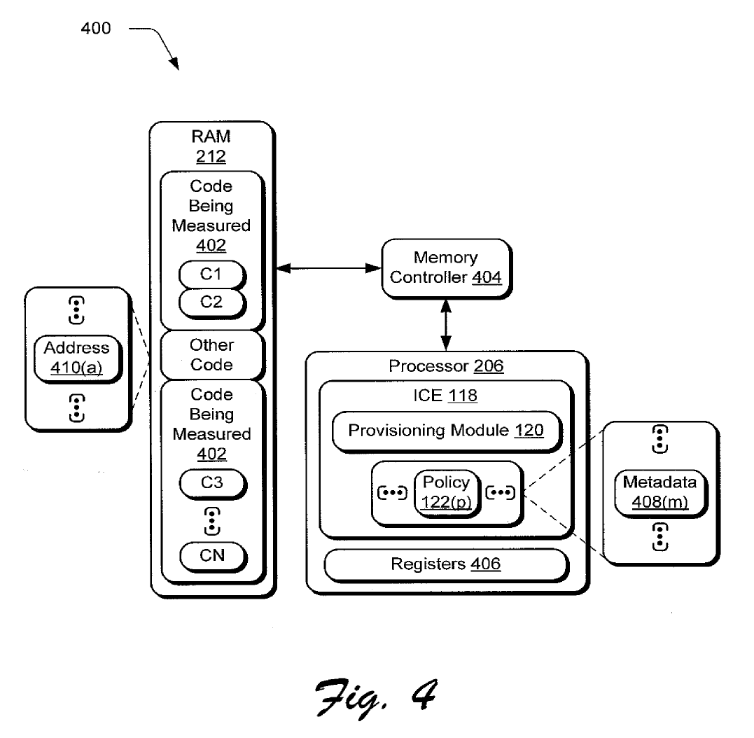

FIGS. 3 and 4 represent examples of an independent (or isolated) computation environment 300 or 400 measuring the health of one or more sets of code 302 or 402 (which may or may not correspond to modules 108(a) of FIGS. 1 and 2) code modules or the like. The code 302 or 402 is illustrated as including portions “C1-CN”, which represent examples of portions of the code running in one or more memory regions in physical memory, which is illustrated as volatile memory configured as RAM 212 but other types are also contemplated.

As should be readily apparent, the one or more sets of code (illustrated as C1-CN) need not be contiguous in the physical memory, as represented in the non-contiguous sets in the RAM 212 represented in FIG. 4. In another implementation, the code is measured in virtual memory, such as by having the virtual memory-related code of the operating system 110 to manipulate virtual-to-physical mapping. In this implementation, virtual-to-physical mapping may be controlled by a trustworthy component, and/or by the ICE 118 described herein to measure the contents and behavior of instructions in the physical memory space.

In the implementation represented in FIG. 3, the ICE 118 is an independent entity (that is, not part of another hardware component such as the processor 206). In the alternative implementation represented in FIG. 3, the ICE 118 is shown as being incorporated into the processor 206, e.g., as part of its circuitry or as independent circuitry in the same physical package. Yet another implementation may rely on software only.

The independent computation environments 118 of FIGS. 2 and 3 each include (or are otherwise associated with) hosted logic (illustrated as provisioning modules 120), and respective installed policies 122(p), any or all of which may be hard wired at least in part and/or injected later for change (e.g., by being flashed, possibly with an expiration time). Part or all of the policy may be within the provisioning module 120 and/or separate from it, e.g., coded into rules. The provisioning module 120 and/or policies 122(p) may be signed, or otherwise known to be valid (e.g., via hard wiring), and may be required to be present on a certain computer or class of computer. Further, different provisioning modules 120 and/or policies 122(p) may apply to different types of computers. As but one example, the provisioning module 120 and/or its related policy 122(p) of the ICE 118 of FIG. 4 incorporated into the processor 206 may be different from the provisioning module 120 and/or its related policy 122(p) of the ICE 118 of FIG. 3.

Although all possible implementations are not shown, it is understood that an independent computation environment may be independent as in FIG. 2, or incorporated into essentially any suitable hardware component, (possibly but not necessarily the processor 206 as in FIG. 4), as long as the independent computation environment is isolated from tampering. Thus, other alternative implementations are feasible. For example, the ICE 118 may be implemented in other hardware, such as in a memory controller, or may be part of special RAM chips, e.g., built into a motherboard. Moreover, while the provisioning module 120 and/or policy 222(p) may be considered part of the ICE 118, there is no physical requirement that it be part of the same hardware component or components, and indeed the independent computation environment may be made up of various, physically distinct hardware components.

For purposes of simplicity herein, the following description will use the reference numerals of FIG. 4 unless otherwise noted. As can be readily appreciated, the physical location of the independent computation environment can vary between embodiments, and thus the discussion of the embodiment of FIG. 4 may apply to a variety of other embodiments, including that of FIG. 3, when describing many of the characteristics of an independent computation environment.

Regardless of any physical implementation/embodiment, ICEs 118 may have a number of characteristics that are similar to one another. For example, the ICE 118 of FIG. 4 provides the provisioning module 120 with reliable access to the RAM 212, where the subject set or sets of code 402 being measured (e.g., the module or modules being monitored/validated/authenticated 108(a) of FIG. 1) reside. In an implementation, to access the RAM 212 the provisioning module 120 does not depend on an operating system 110 side agent for access, because the operating system could be compromised. The measured code 402 may reside anywhere in RAM 212, as long as the ICE 118 has a way of knowing “where” it is. For example, the ICE 118 may use offsets, and/or may have an instruction pointer to a window (or pointers to windows) in the RAM 212 or other memory. Another, somewhat simpler option is to ensure that the set of code 402 to be measured resides in the same physical address space.
The memory section or sections that contain the measured code sets (e.g., C1-Cn) may be watched by some mechanism, referred to as a memory watch component, or memory watchdog. In general, a memory watchdog fires exceptions/events upon attempts to modify at least one designated location in memory; (note that at least one “location” includes as little as a single location, or any contiguous or non-contiguous range, memory block or set of blocks). This relates to any memory modification, including processor-originated and peripheral-originated RAM write requests. The memory controller 304 or 404 may be configured to provide such events, and thus should also be based on hardware that cannot be easily compromised, however it is understood that a memory watch component/watchdog may comprise software or hardware, or a combination of software and hardware.

Various techniques for handling memory watchdog exceptions may be used. For example, in one implementation, the processor 206 may be halted during such exceptions until clearance by the provisioning module 120 and/or policy 122(p) of the ICE 118. Alternatively, the ICE 118 may instead otherwise penalize the system state (e.g., block the problematic code, reduce the system, reset the system or otherwise activate some enforcement mechanism) upon an attempt to alter modify the RAM in the region of the subject code 402. Another alternative is to have the independent computation environment block write access to the subject code 402.

With respect to the measurements of the subject code 402, the provisioning module 120 may use a variety of techniques. For instance, hashes/digital signatures/certificates and/or other mathematical computations may be used to authenticate that a correct set of binary code is present where it should be, such as based on digital signature technology (e.g., according to Cert X.509 and/or Rivest, Shamir & Adelman (RSA) standards) that may be compared to one or more corresponding values in the policy 122(p). Alternatively, if the measured code is relatively small, the provisioning module 120 may simply evaluate its instructions, or some subset thereof, against values in the policy that match the instructions. Still another option is statistical or similar analysis of the code, e.g., such as a pattern in which it executes, as described below. Any combination of measuring techniques may be employed.

It should be noted that the computations that may be taken to evaluate the memory may take a significant amount of time to perform. Indeed, the watched range may change while the range of memory is being read, e.g., linearly. Thus, depending on policy, the watchdog may trigger a re-read upon any change during the reading operation so that the memory that was already read cannot be changed behind the location currently being read. The policy may specify that this is allowable, or may specify trying again, and if so, how often (e.g., up to some limit), and so forth.

Thus, the provisioning module 120 may obtain data about the health of the subject code 402 in various ways. One way to obtain health data is for the independent computation environment to set soft-ICE-trap instructions in points of interest in the code 402. Alternatively, or in addition to the trap technique, the hardware (e.g., the processor 206) may allow the ICE 118 to ask for statistics about execution of the subject code 402. This may be accomplished by defining registers (306 or 406) or the like that trigger the counting of execution of certain binary instructions or ranges of instructions. Note that if present, these registers 306 or 406 may be in the hardware to avoid tampering, such as exemplified as being part of the independent computation environment 118 of FIG. 3 or in the processor 206 of FIG. 4.

Note that the measured code of interest may have accompanying metadata, which may be schematized as a part of the code being measured as illustrated by metadata 308(m) of FIG. 3 and/or stored as part of the policy 122(p) as illustrated by metadata 408(m) of FIG. 4. The metadata 308(m), 408(m) may describe a variety of information, such as what sort of statistics are to be gathered, a description of how a healthy module should look, “where” a healthy module should be executed (e.g., data registers, memory addresses), inclusion and/or exclusion lists, network addresses that are permitted to be accessed during execution of the module, and so on. The metadata 308(m), 408(m) may be provided by the module author and/or a computing device provider, e.g., manufacturer or seller. For example, metadata 308(m), 408(m) may specify that the ICE 118 should have control of the processor 206, 306 ten-to-fifteen times per second, that the instruction at some address (e.g., A1) in the subject code 302 should be executed ten times for each time the instruction at some other address (e.g., A2) is executed, and so forth.

Further examples of metadata 308(m), 408(m) that may be associated with a set of subject code to describe its health characteristics to the ICE 118 (that is essentially standing guard to validate compliance) include digital signature(s) for integrity and/or authentication checks, and/or expected number of times the module gets to execute per period (e.g., second, minute, or other). This number of execution times may be a range, and may be as general as the entire set of code, and/or more specific to the granularity of instruction ranges or specific instructions. Instead of or in addition to execution statistics, a statistical evaluation of how often the code resides in memory may be evaluated, e.g., a module may have to be loaded into memory some threshold amount (or percentage) of time, and/or only may be not in the memory for a specified amount of time, (or number of times per second, minute and so forth).

Still another example of metadata 308(m), 408(m) includes the expected values of certain registers (e.g., the data registers 310(r) of FIG. 2) and/or memory addresses (e.g., the addresses 410(a) of RAM 212 in the computing device of FIG. 3) at certain instructions. This may be pronounced as a distribution, e.g., as various values or ranges of values with a probability weight. Another type of metadata 308(m), 408(m) may specify a relationship between the expected values of several registers and memory addresses; for example, if one variable is less than ten (Var1<10), another variable has to match certain criteria, (e.g., 50 percent of the time variable Var2 is greater than, 25 percent of the time is greater than 100, and sometimes may be 399; Var2 should never be less than zero).

Other examples of metadata 308(m), 408(m) include those based on instructions. Instructions may be counted for the number of times they execute relative to other instructions, optionally with statistics/ratios used for evaluating good counts versus bad counts, so that a small number of occasional differences may be tolerated. When something looks suspicious but is not necessarily a definite violation, the policy may change to run a different algorithm, change variables, watch more closely or more frequently, and so forth.

Yet other examples of metadata 308(m), 408(m) include those which describe where and how data is stored. For example, the metadata 308(m), 408(m) may describe a particular memory addresses (e.g., the addresses 410(a) of FIG. 4), in which, a module is to be stored, particular data registers 310(r) in the processor 206 of FIG. 3, and so on. In this way, the metadata 308(m), 408(m) may specify a “bubble”, in which, execution of the code 202, 302 is permitted by monitoring attempts to interact with the data registers 310(r) and/or addresses 410(a), such as by monitoring control bits, pointers, status bits, and so forth.

Additionally, access to the “bubble” may also be provided in a variety of ways, such as “explicit” in which read access is provided to other modules (e.g., the operating system 110) and “implicit” in which access to the bubble is limited to the provisioning module 120 and prevented by other modules (in other words, the bubble and its existence is contained within the bounds of the ICE 118). One or more optional APIs may be provided to facilitate operation, such as Ice.BeginMemoryAddess( ), Ice.EndMemoryAddress( ), Ice.AccessPermitted( ), and/or others.

Using the metadata and/or other techniques, the ICE 118, via the provisioning module 120 and policy 122(p), may measure and validate the integrity and authenticity of any specified set of code (e.g., C4). For example, the ICE 118 may be programmed to look for a certain set of one or more modules, or expect a policy that specifies which module or modules are to be validated.

During normal operation, the provisioning module 120 may be activated by an operating system request. For example, the ICE 118 may (via an internal timer) gives the operating system a grace period to initiate the validation measurement, and if this time elapses, the independent computation environment may deem the system corrupt (unhealthy) and take some penalizing action.

Note that with respect to measurement time, as described above, one option is to specify that a set of subject code to be measured (e.g., C3) is to reside in the same physical address space. In such a situation, the ICE 118 may attempt verification speculatively, including at random or pseudo-random times.

Before starting the measurement process, the provisioning module 120 may “lock” some or all of the subject code, also referred to as target modules. One implementation uses the above-described memory-altering watchdog to ensure that the subject code is not changed in the watched region or regions. Another measuring technique may lock the memory for write accesses.

To this end, the provisioning module 120 may provide the operating system some interface (which may be explicit or possibly implicit) to repurpose the RAM 212. An explicit interface would allow the operating system 10 to notify the ICE 118 about its intent to repurpose the RAM; in general, this may be viewed as the operating system 110 asking the ICE 118 for permission to repurpose the RAM 212. One or more optional APIs may be provided to facilitate operation, such as Ice.AskPermissionToRepurposeMemory( ), Ice.SetValidationPolicy( ), Ice.SuggestModuleAddress( ), Ice.UpdateModuleMetaInfo( ), and/or others.

An implicit interface can be based on the memory-watchdog-exception, which is interpreted by the ICE 118 as a request to permit RAM repurposing. Along these lines, there are times when the ICE 118 does not care how the memory is repurposed, e.g., at times when the code is not being measured. For example, metadata may indicate that a set of code is to be measured ten times per second, and during non-measuring times the operating system can use the memory any way it wants.

Upon a RAM repurposing request, the ICE 118 may implicitly or explicitly grant the request. In any case, the ICE 118 still stands guard to ensure the health of the code being measured, as subject to the metadata associated with that measured code.

By way of example, given an independent computation environment (e.g., hierarchical, system-based or a similar “root of trust”), various features are desirable to enable modular-authentication.

In general, the ICE 118 provides reliable read access to memory of the computing device 104, e.g., volatile memory such as RAM 212. The provisioning module 120 assumes that the read operations are neither virtualized, nor re-mapped to other memory or I/O space, nor filtered or modified in another manner; (at present, contemporary BIOS can leverage a subset of this when the hardware follows best practices about the chipset). The ICE 118 also may enable the provisioning module 120 to set watchdogs on certain memory areas that will trigger one or more signals upon each modification of the contents of these memory areas. The watchdog provides alerts about any memory contents change in the physical memory space, including changes originated by direct memory accesses (DMAs) and bus master. Note that an existing x86-based computer system may incorporate an ICE into its BIOS by having the BIOS host a provisioning module, e.g., one that can measure subject code as long as the subject code remains fixed in a particular memory range.

The ICE 118 may further enable the provisioning module 120 to obtain statistics about the instruction pointer's appearance in certain memory ranges. For instance, an instruction pointer-watchdog may be used to alert the ICE 118 every time the instruction pointer gets into and out of specified memory range(s) of interest. Other models are viable, including the register-based model described above.

As also described above, the ICE 118 also may be configured to observe/attest as to the sort of activity of the code being measured. For example, the author can describe (e.g., in metadata) a module's characteristic behavior in a variety of ways, as long as the independent computation environment can measure and evaluate the behavior. As long as that module behaves within the specified behavior (e.g., performance) envelope, that module is considered healthy.

By way of example, a relatively straightforward characteristic to profile and follow is input/output (I/O) operation. To this end, the authenticated modules may be fastened in such a way that if stolen (e.g., placed into the image of another operating system), the modules will have to be kept healthy to pass the modular authentication successfully. As a result, if these modules are placed into the code of another operating system, they will have to get control and direct access without virtualization (except in the hardware device itself).

As another example, the authenticated module may have specified behavior pertaining to particular one or more network addresses, with which, the module may interact. For instance, the provisioning module 120 may monitor the code 304 to ensure that the code 304 is pointed to a “correct” network address (e.g., uniform resource locator (URL), Internet protocol (IP) address, and so on), such as that specified by metadata, a policy 122(p), and so on.

As described above, the ICE 118 may continuously monitor the code being measured 302, but depending on the policy 122(p), may instead only monitor the code 302 at times the policy 122(p) deems appropriate. As a result, code that is not monitored continuously may be swapped into memory, such as according to policy, with measurement or statistical gathering taking place on the code during the time that it is swapped into memory.

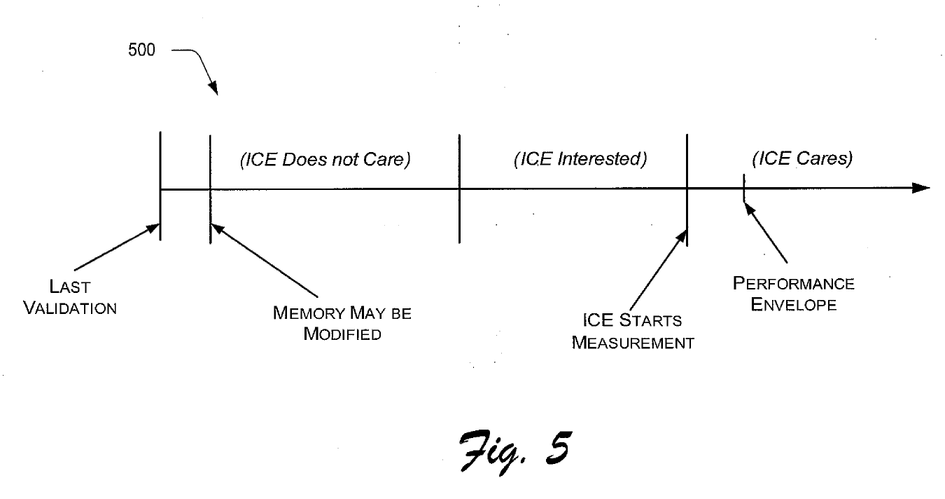

FIG. 5 shows an example timing diagram in which the ICE 118 occasionally measures (e.g., periodically or on some event, or even randomly) about what code is present and/or how it is operating. Note that FIG. 5 is a timing diagram for what is in the memory; with a statistical-based analysis, e.g., how many times certain instructions of the code are executed relative to other instructions, or with a frequency-based analysis, e.g., how many times certain instructions of the code are executed per time period, the “ICE does not care” region can essentially span the entire time, as long as the counts (e.g., in the registers) are correct whenever measured, which may be fixed or sporadic.

The policy 122(p) will typically decide on when and what kind of measuring is needed. For example, the timing diagram exemplified in FIG. 5 does not require that the code being measured remain in memory at all times. Thus, there is an “ICE does not care” time frame that follows (except for the first time) a previous measurement complete state, referred to in FIG. 5 as “Last Validation.” In this time frame, the operating system can swap in new code or otherwise leave whatever it wants in the corresponding measured region or regions, because they are not being measured at that time. If locked, the memory region may be unlocked at this time.

In the “ICE interested” time, the ICE 118 may start its measurement such as to reset counters and the like, although if not correct in this time frame, no enforcement may be done. This time frame may also correspond to the above-described grace period in which the operating system is given time to complete something, as long as it triggers the independent computation environment's measurement before the grace period expires. In this manner, the ICE 118 may or may not operate, but no penalty will be assessed unless and until some violation is later detected.

When the independent computation environment does measure, in the “ICE Cares” time frame, the measurement needs to be started and correct at the time that is shown as “Performance Envelope” is reached, or some type enforcement will be activated. Again, the policy determines the timing, the type of measurement, the type of enforcement and so forth.

In general, when the validation fails, or some or all of the describing policy (e.g., comprising any data used by the provisioning module 120) is absent, the ICE 118 penalizes the computer system by changing its state in some way, as generally described above. For example, when the code that is in memory is not the correct set of code and/or is not behaving correctly at the measuring time, the enforcement mechanism is activated, e.g., to halt the system. Other examples include locking the computer system, slowing down the computer system, limiting memory in some way, slowing I/O, affecting (e.g., killing) a relevant process via trap instructions, overwriting process code (e.g., with infinite loop instructions), and so forth. The independent computation environment may alert the overlaying operating system prior 110 to taking any penalizing acts.

It should be noted that numerous combinations of timing, the types of measurement, the types of enforcement and so forth may vary between classes of computers, or even in the same computer system itself. For example, in the same computer, one code module being evaluated may have to physically reside in the same location in memory at all times, another module may be swapped in and out but have to be present at measuring time, yet another module may be swappable at any time but have to periodically meet performance requirements (meaning it has to be executed often enough to do so), and so forth.

It should be noted that the enforcement that is taken may vary when a violation is detected, and different types of violations may result in different types of enforcement. For example, changing one (e.g., highly critical) code module may result in the system being shut down by the ICE, whereas changing another may result in the operating system being notified so as to present a warning to the user or send a message to the computer system manufacturer, program vendor or the like (e.g., some licensing entity). As another example, as described above, missing a statistic may not result in an immediate penalty, but instead will result in more careful watching, at least for awhile, to determine if further enforcement should be taken.

Exemplary Procedures

The following discussion describes provisioning techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environments of FIGS. 1-4.

FIG. 6 depicts a procedure 500 in an exemplary implementation in which a subsidized computing device is provided that is bound to one or more web services. A computing device is provided that is bound to access one or more web services of a service provider (block 602). For example, the computing device 104 of FIG. 2 may execute a provisioning module 120 which limits access to particular web services 116(w) through inclusion and exclusion lists. In another example, the provisioning module 120 limits execution to modules that are configured to access particular web sites and not other web sites. A variety of other examples are also contemplated.

At least a portion of a purchase price of the computing device is subsidized (block 604). For example, the service provider may collect revenue obtained due to interaction of the computing device with the one or more web services (block 606), such as due to advertising, fees collected from a user of the computing device for interaction with the web services, fees collected from the user to interact with the computing device itself (e.g., pay-per-use), and so on. Thus, these fees may be used to offset the purchase price of the computing device, which encourages the consumers to purchase the computing device and subsequently interact with the web services. The computing device may be bound to the web services in a variety of ways, further discussion of which may be found in relation to the following figures.

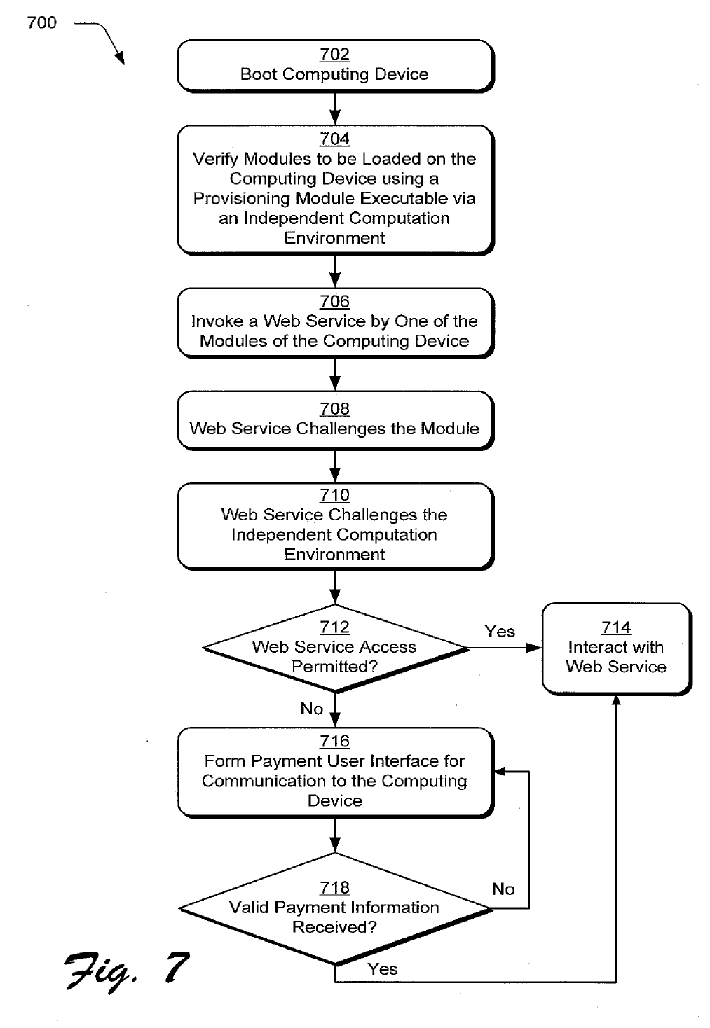

FIG. 7 depicts a procedure 700 in an exemplary implementation in which a module is executed on a computing device which is bound to interaction with a particular web service. A computing device is booted (block 702), such as by receiving a “power on” input from a user.

Modules to be loaded on the computing device are verified using a provisioning module that is executable via an independent computation environment (block 704). The provisioning module 120, for instance, may be executed within the ICE 118 and verify that modules 108(a) are authentic, such as by authenticating signatures of the modules 108(a) using a secret 226 (e.g., an encryption key) stored in the computing device 104, certificates, and so on. As before, the modules 108(a) may be configured in a variety of ways, such as an operating system, network access module (e.g., a browser), and so on.

A web service, for instance, may be invoked by one of the modules of the computing device (block 706), such as by a browser in response to an input received from a user of the computing device, a “smart” module having network access functionality, and so on.

The web service challenges the module (block 708), such as by verifying the module using an encryption key to determine that the module is authorized to interact with the web service. The web service may also challenge the independent computation environment (block 710), such as by interacting with the provisioning module 120 to verify the computing device using the secret 226. Based on the challenges, a determination is made as to whether web service access is permitted (decision block 712). If access is permitted (“yes” from decision block 712), the computing device interacts with the web service (714), such as to read email, upload pictures, purchase media (e.g., songs, movies), and so on.

When web service access is not permitted (“no” from decision block 712), however, a payment user interface is formed for communication to the computing device (block 716). The payment user interface may act as a “front end” of a payment entity (e.g., the service provider, third-party collection service, and so on) that is configured to receive payment information. When valid payment information is received (“yes” from decision block 718), the computing device interacts with the web service (block 714). If not (“no” from decision block 718, the payment user interface is still output (block 716). For example, the payment user interface may be output during a hardware lock mode, in which, modules 108(a) “outside” of the independent computation environment are not permitted to execute, including an operating system, until payment information is received and the computing device “unlocked”. A variety of different techniques may be used “meter” the use of the computing device, further discussion of which may be found in relation to the following figure.

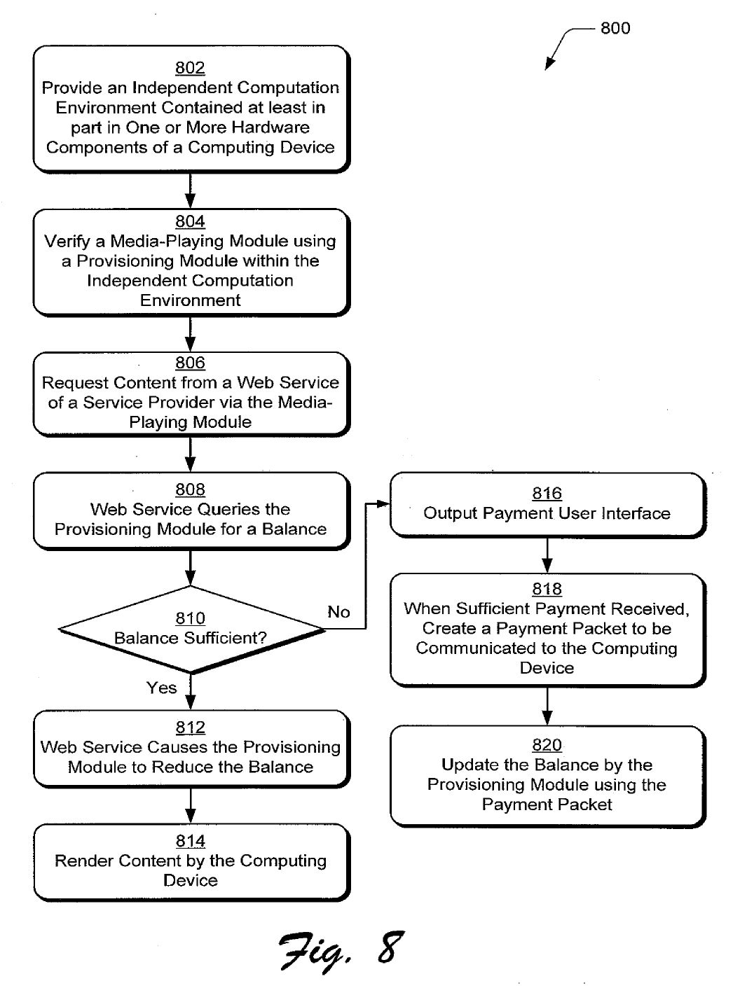

FIG. 8 depicts a procedure 800 in an exemplary implementation in which a balance is used to manage functionality of a computing device through execution of a provisioning module in an independent computation environment. As previously described, an independent computation environment is provided that is contained at least in part in one or more hardware components of a computing device (block 802). The provisioning module in this example is configured to verify modules that are to be executed on the computing device.

For example, an input may be received to launch a media-playing module (e.g., that is configured to output audio and/or video media) from a user. Upon detection of the input, the provisioning module executed within the independent computation environment verifies the media-playing module (block 804), such as by checking digital signatures, certificates, cryptographic hashing and comparison with inclusion/exclusion lists, and so on. If successfully verified, the media-paying module is permitted to be executed on the computing device.

Content is requested from a web service of a service provider via the media-playing module (block 806), such as a request to download a particular movie, song, and so on. In response to the request, the web service queries the provisioning module for a balance (block 808), which is passed to the web service. For example, the provisioning module may read the balance 224 from secure storage 214 and expose this to the manager module 216 of the service provider 104. When the balance is sufficient (“yes” from decision block 810), the web service causes the provisioning module to reduce the balance (block 812), such as by passing the content to provisioning module 120 which is then unlocked and the balance 224 reduced. The computing device may then render the content (block 814), such as through execution of the media-playing module.

When the balance is insufficient (“no” from decision block 810), a payment user interface is output (block 816). For example, the payment user interface may direct a user to a web site, via which, the user may submit payment information, such as user name, password, credit card information, and so on. When sufficient payment is received, a payment packet is created to be communicated to the computing device (block 818). The provisioning module may then use the payment packet to update the balance (block 820), such as by decrypting the payment packet using the secret 226 and updating the balance 224 based on instructions in the packet. A wide variety of other instances are also contemplated to update and use a balance to control functionality of the computing device 104, such as a “pay-as-you-go” business model in which the balance is decremented over a period of time during operation of the computing device 104 and the balance is updated to continue use of the computing device 104.

FIG. 9 depicts a procedure 900 in an exemplary implementation in which inclusion and exclusion lists are used to manage functionality of a computing device. A request is monitored to interact with particular functionality (block 902). The provisioning module 120, for instance, may be executed to monitor requests to launch a particular one of the modules 108(a), interact with a particular web service 116(w), and so on.

The particular functionality is identified (block 904). The provisioning module 120, for instance, may identify the web service 116(w) via a network address, identify a module 108(a) through cryptographic hashing, digital signatures, certificates, and so on. A determination is then made by the provisioning module, which is executable in the independent computation environment, whether access to the particular functionality is permitted (block 906).

The provisioning module 120, for instance, may implement a policy 122(p) that specifies that access is to be managed through use of an inclusion list 218, exclusion list 220 and conditions 222. The provisioning module determines whether the particular functionality is included on the inclusion list 218 (decision block 910). If so (“yes” from decision block 908), access to the particular functionality is permitted (block 910).

When the particular functionality is not on the inclusion list (“no” from decision block 908), a determination is made as to whether the particular functionality is on an exclusion list (decision block 912). If so (“yes” from decision block 912), access to the particular functionality is prevented (block 914).

When the particular functionality is not on the exclusion list (“no” from decision block 912), one or more conditions are applied regarding access to the particular functionality (block 912). For example, access to functionality not specified in the lists may be permitted for a predetermined amount of time (e.g., a number of cycles) to give an opportunity for the lists to be updated to specify a policy that addresses the particular functionaliyt. In another example, the conditions may be applied based on the functionality employed, such as a module that is configured for network access may have the network access limited, a module without such access may be permitted to execute, and so on. A variety of other examples are also contemplated.

FIG. 10 depicts a procedure 1000 in an exemplary implementation in which different identification techniques are used in conjunction with respective inclusion/exclusion lists to manage execution of a module. A request is monitored to launch a particular module (block 1002).

The particular module is identified using a first identification technique (block 1004). For example, a cryptographic hash may be performed of the particular module. A determination is then made as to whether the identified module is on an inclusion list (block 1006), and if so, access to the particular functionality is permitted (block 1008). Therefore, in this example, a “precise” identification technique is used to identify the module to limit access by other modules which attempt to mimic the modules referenced in the inclusion list, such as to prevent piracy and so on.

Additionally, the inclusion list, exclusion list, conditions and/or identification techniques may be updated (block 1010) during operation of the computing device 104. For example, the service provider 102 may communicate updates to address “new” functionality, such as newly-identified pirated copies of application modules.

When the module is not on the inclusion list (“no” from decision block 1006), the particular module is identified using a second identification technique that is less precise than the first identification technique (block 1012). For example, the first identification technique may be cryptographic hashing and the second may be digital signatures, the first may be a third-party verified certificate and the second may be a self-signed certificate, and so on.

A determination is then made as to whether the module identified using the second technique is on the exclusion list (decision block 1014). If so (“yes” from decision block 1014), the access to the particular module is prevented (block 1016). If not (“no” from decision block 1014), one or more conditions are applied regarding access to the particular module (block 1018), such as limiting which memory spaces may be accessed by the module, limiting network access, permitting execution of a predetermined amount of time, and so on. Although use of different identification techniques was described in relation to a particular module, the use of different identification techniques and lists may be applied to a wide variety of other functionality, such as web services and so on.

### CONCLUSION

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method comprising executing a provisioning module in an independent computation environment that is contained at least in part in one or more hardware components of a computing device to bind network access of the computing device to one or more web services.

2. A method as described in claim 1, wherein the provisioning module binds the computing device to one or more web services through use of an inclusion list.

3. A method as described in claim 1, wherein the provisioning module binds the computing device to one or more web services through use of an exclusion list.

4. A method as described in claim 1, wherein:
the computing device is bound such that access to the one or more web services is made available without use of personally identifiable information of a user; and
access to another web service is made available through use of personally identifiable information.

5. A method as described in claim 1, wherein the independent computation environment is protected from unauthorized access by other modules of the computing device including an operating system.

6. A method comprising:
providing a computing device bound to access one or more web services of a service provider through use of a provisioning module that is executable in an independent computation environment contained at least in part in one or more hardware components of the computing device; and
subsidizing at least a portion of a purchase price of the computing device.

7. A method as described in claim 6, wherein the computing device is bound such that access to the one or more web services is made available without use of personally identifiable information of a user.

8. A method as described in claim 6, wherein the subsidizing is performed by the service provider.

9. A method as described in claim 6, wherein the subsidizing is performed through collection of ad revenue by the service provider.

10. A method as described in claim 6, wherein:
the subsidizing is performed through collection of fees from a user of the computing device to maintain a balance on the computing device; and
the balance is used by the provisioning module to manage access to functionality of the computing device.

11. A method as described in claim 6, wherein the binding is performed through use of an inclusion list that specifies web services that are permissible to access by the computing device and an exclusion list that specifies web services that are not permitted to be accessed by the computing device.

12. A computing device comprising:
secure storage configured to maintain:
an inclusion list that references functionality that is permitted to be accessed via the computing device; and
an exclusion list that references functionality that is not permitted to be accessed via the computing device; and
one or more hardware components configured to provide an independent computation environment, in which, a provisioning module is executable to identify functionality and determine whether access to the identified functionality is permitted through use of the inclusion and exclusion lists.

13. A computing device as described in claim 12, wherein:
the secure storage is further configured to maintain conditions; and
the provisioning module is executable to determine how access is to be permitted to the identified functionality when the identified functionality is not referenced by the inclusion list and the exclusion list.

14. A computing device as described in claim 13, wherein the conditions permit the identified functionality to execute on the processor for a specified number of cycles, after which, execution is blocked.

15. A computing device as described in claim 13, wherein the independent computation environment is protected from unauthorized access by other modules of the computing device including an operating system.

16. A computing device as described in claim 13, wherein the inclusion list or the exclusion list expires after a predetermined amount of time, after which, a hardware lock mode is implemented by the provisioning module.

17. A computing device as described in claim 13, wherein the inclusion list or the exclusion list includes one or more conditions regarding enablement of the particular functionality.

18. A method as described in claim 17, wherein at least one of the conditions specifies:
a particular amount of time, during which, access to the particular functionality is permitted; or
that payment is to be collected by a service provider before enabling the particular functionality.

19. A method as described in claim 17, wherein at least one of the conditions specifies proof of consumption of an advertisement.

20. A computing device as described in claim 13, wherein:
the particular functionality is identified using a first technique to determine whether the particular functionality is referenced in the inclusion list;
the particular functionality is identified using a second technique to determine whether the particular functionality is referenced in the exclusion list; and
the first technique is different from the second technique.
